(19) United States
(12) Patent Application Publication
(10) Pub. No.: US 2022/0146052 A1
(43) Pub. Date: May 12, 2022

(54) MONITOR CONTROL VALVE WITH BACKFLOW PREVENTION

(71) Applicant: VRG Controls LLC, Lake Zurich, IL (US)

(72) Inventors: Vladimir Rimboym, Highland Park, IL (US); James M. Garvey, Wheaton, IL (US)

(21) Appl. No.: 17/453,731

(22) Filed: Nov. 5, 2021

Related U.S. Application Data
(60) Provisional application No. 63/110,522, filed on Nov. 6, 2020.

(51) Int. Cl. F17D 3/01; F17D 5/00; G05D 7/06

(52) U.S. Cl. CPC F17D 3/01; G05D 7/0635; F17D 5/005

(57) ABSTRACT

A gas supply line control system and method for preventing flow reversal due to an upstream pressure drop in a natural gas supply line, the system and method include setting a threshold low pressure for the upstream gas flow, continually sensing the upstream pressure, activating a trigger valve when the upstream pressure falls below the threshold low pressure, and closing a control valve in response to the trigger valve to prevent reversal of flow in the gas supply line.

### RELATED APPLICATION

The present application claims the filing priority of U.S. Provisional Application No. 63/110,522, titled “Monitor Control Valve with Backflow Prevention” and filed on Nov. 6, 2020. The '522 application is hereby incorporated by reference.

### TECHNICAL FIELD OF THE INVENTION

The present invention relates to control systems. More specifically, the invention relates to flow and pressure control systems for natural gas lines.

### BACKGROUND OF THE INVENTION

In current natural gas line control systems, a significant drop in upstream or supply side pressure (P1) creates a potential backflow from the downstream or delivery side natural gas lines. This is an extremely undesirable occurrence. To prevent such a backflow condition, a backflow prevention valve—i.e., a check valve—is usually installed into the gas line upstream of the control valve (See FIG. 1). This is a costly undertaking for natural gas suppliers and requires annual maintenance and certification of operation.

A significant upstream pressure drop (abnormal operating condition) is typically the result of a pipeline rupture or other significant event causing an upstream loss of gas. Normal upstream pressure is between 230 to 500 psig, while downstream pressure is generally maintained by regulators at 160 psig.

The use of a Monitor Control Valve has been used by the Assignee of this invention, VRG Controls, LLC., for many years as a way of providing “over-pressure” protection in a natural gas pipeline. FIG. 2 illustrates a normal gas flow where P2 is less than P1 due to pressure reduction maintained by a worker regulator 20. As illustrated in FIG. 2, a monitor regulator 22 positioned upstream of the worker regulator 20 is in standby mode during normal operation. As shown in FIG. 3, the monitor regulator 22 takes over to throttle gas flow when the downstream pressure at P2 begins to exceed 160 psig. The onset of this over-pressure condition is often due to a failure of the worker regulator 20. In the event of an upstream rupture, as illustrated in FIG. 4, pressure at P1 drops significantly due to the loss of gas. When the pressure at P1 falls below pressure at P2, a reverse flow scenario is created. The worker regulator 20 and monitor regulator 22 cannot act to prevent the reverse flow, leading to a significant loss of product, loss of revenue, and unsafe conditions due to release of flammable media to atmosphere.

Unfortunately, the potential occurrence of flow reversal in a natural gas line has only been addressed by the addition of a backflow prevention valve i.e., a check valve. The gas line arrangement illustrated in FIGS. 5-7 shows a typical check valve 24 positioned upstream of the two regulators, 20 and 22. FIG. 5 shows normal gas line conditions, where P2 is less than P1 and gas flow is regulated by the worker regulator 20. FIG. 6 illustrates a worker regulator failure, causing the monitor regulator 22 to take control of pressure regulation, much like the system of FIG. 3 explained above. In neither of these two scenarios does the check valve 24 interrupt flow. However, FIG. 7 illustrates a pipeline rupture upstream causing a drop of pressure at Pl. The loss of pressure at P1 is almost immediate, but the check valve 24 will only close when the P1 pressure falls to or below P2 pressure. This equalization can take time after the occurrence of a line rupture.

Accordingly, a failsafe system is needed which can address both an over-pressure scenario as well as a reverse flow scenario in a gas line. Further, a failsafe system possesses an adjustable setpoint capable of responding to an upstream pressure drop well before pressure equalization is also desirable. This feature lessens the volume of gas lost to atmosphere in the event of a flow reversal due to rupture of the pipeline which benefits safety and lessens the potential of undersupplying gas consumers downstream of the pipeline rupture. Finally, a failsafe system which, unlike a check valve, is not costly to install and costly to maintain is most desirable.

Until the invention of the present application, these and other problems in the prior art went either unnoticed or unsolved by those skilled in the art. The present invention provides a system control for gas lines which performs multiple functions with associated devices potentially without requiring expensive retrofitting of valves in existing gas lines.

### SUMMARY OF THE INVENTION

There is disclosed herein an improved natural gas line control system and methods which avoid the disadvantages of prior devices, systems and methods while affording additional structural and operating advantages.

Currently, a MONITOR CONTROL VALVE provides OVERPRESSURE PROTECTION on pipeline. This means that if the WORKER (primary) CONTROL VALVE FAILS, then the MONITOR CONTROL VALVE takes control limiting downstream pressure. However, the disclosed MONITOR CONTORL VALVE system is altered to now include a “flow reversal prevention” feature which prevents reversal of flow if UPSTREAM PRESSURE drops to predetermined setpoint. Addition of an UPSTREAM PRESSURE SENSOR and TRIGGER VALVE to prevent “flow reversal” is a new combination. The configuration eliminates the need for a customer to install a separate CHECK VALVE component in the pipeline to prevent “flow reversal.” . The system may incorporate almost any type of control valve that can exhibit flow shutoff and has a mechanically actuated system that will guarantee closure of the valve upon loss of pneumatic supply pressure.

Generally speaking, the gas supply line control system comprises a control valve having an inlet, an outlet, and a mechanism for moving between an open and closed position to control gas flow from the inlet to the outlet, wherein gas flows from upstream to the inlet, to downstream through the outlet, a pressure sensor for determining an upstream side line pressure, and a trigger valve responsive to the pressure sensor for operating the control valve. The trigger valve closes the control valve mechanism when the pressure sensor determines an upstream pressure below a predetermined value to prevent reverse flow of gas.

The gas supply line control system work with one of almost any type of control valve that can exhibit flow shutoff and has a mechanically actuated system that will guarantee closure of the valve upon loss of pneumatic supply pressure.

A method for preventing flow reversal due to an upstream pressure drop in a natural gas supply line, the method comprising setting a threshold low pressure for the upstream gas line, continually sensing the upstream pressure, activating a trigger valve when the upstream pressure falls below the threshold low pressure, and closing a control valve in response to the trigger valve to prevent reversal of flow in the gas supply line.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic showing a prior art approach which splices a check valve into a gas line upstream of flow control regulators to prevent reverse flow in the event of a line rupture;

FIG. 2 is a schematic showing normal operation of a standard gas line regulation system with a worker regulator and an upstream monitor regulator−worker control valve in control;

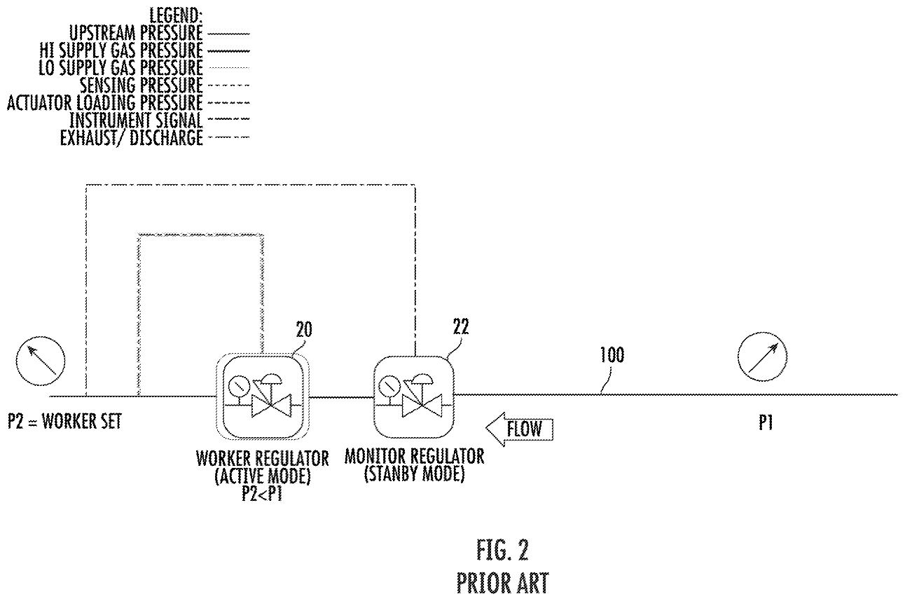

FIG. 3 is a schematic showing operation of a standard gas line regulation system with a worker regulator and an upstream monitor regulator after failure of a worker regulator and activation of the monitor regulator;

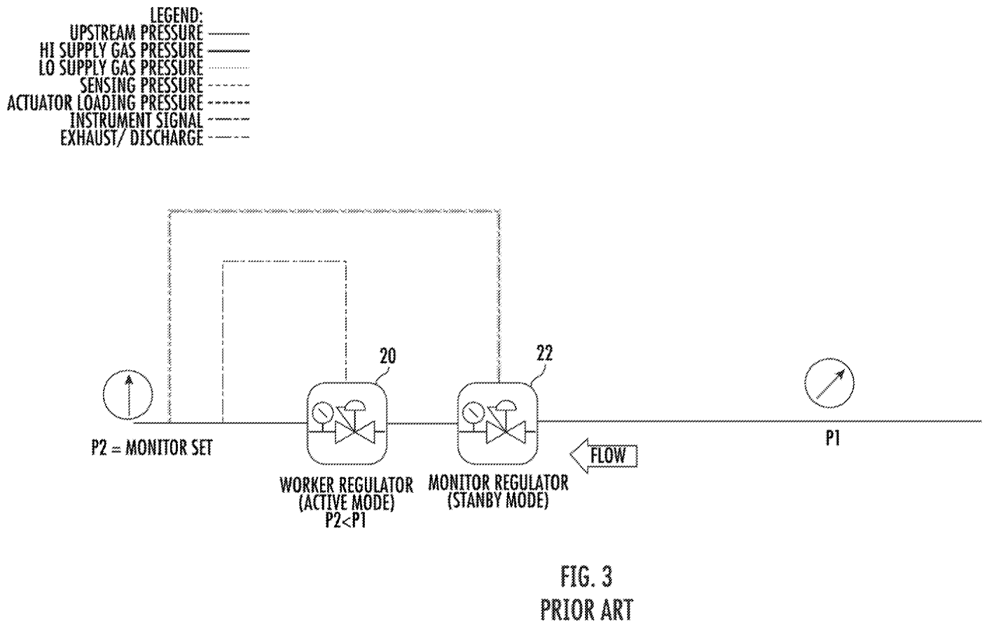

FIG. 4 is a schematic showing operation of a standard gas line regulation system with a worker regulator and an upstream monitor regulator after a gas line rupture upstream;

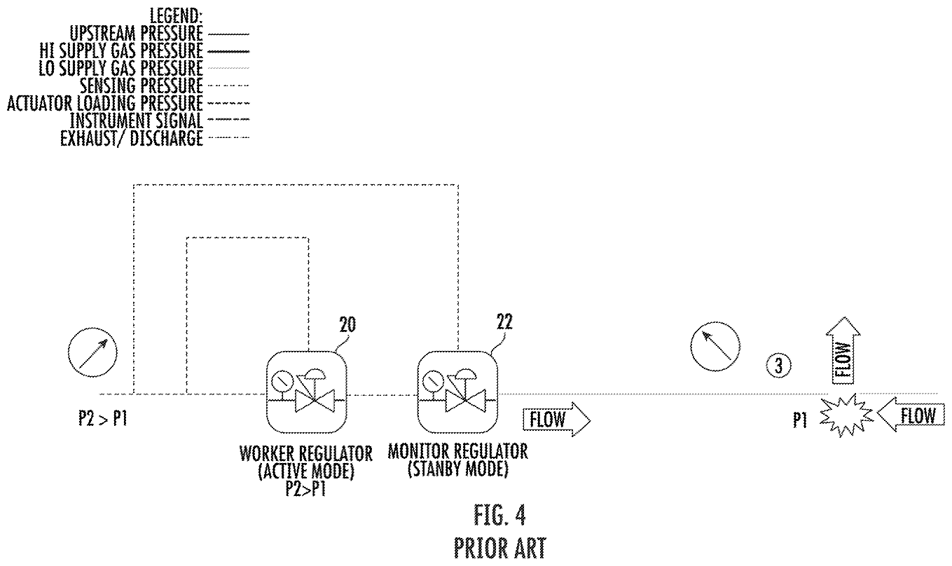

FIG. 5 is a schematic showing normal operation of a standard gas line regulation system with a worker regulator and an upstream monitor regulator having an upstream check valve—worker valve in control;

FIG. 6 is a schematic of the system of FIG. 5 showing operation after failure of the worker regulator—monitor valve in control;

FIG. 7 is a schematic of the system of FIG. 5 showing operation after a pipeline rupture upstream—check valve engaged to prevent flow reversal;

FIG. 8 is a schematic showing normal operation of an embodiment of the disclosed gas line regulation system—worker valve in control;

FIG. 9 is a schematic of the system of FIG. 8 showing operation after failure of the worker regulator—overpressure prevention logic of monitor valve in control; and

FIG. 10 is a schematic of the system of FIG. 8 showing operation after a pipeline rupture upstream—backflow prevention logic on monitor in control.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

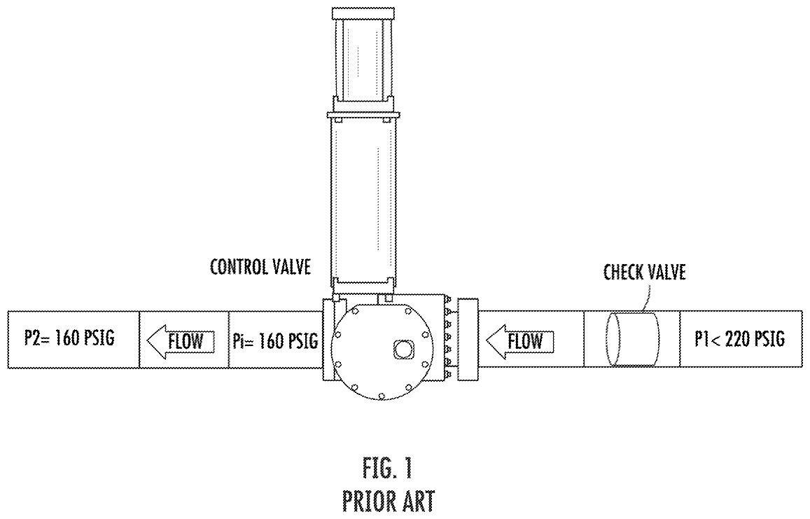

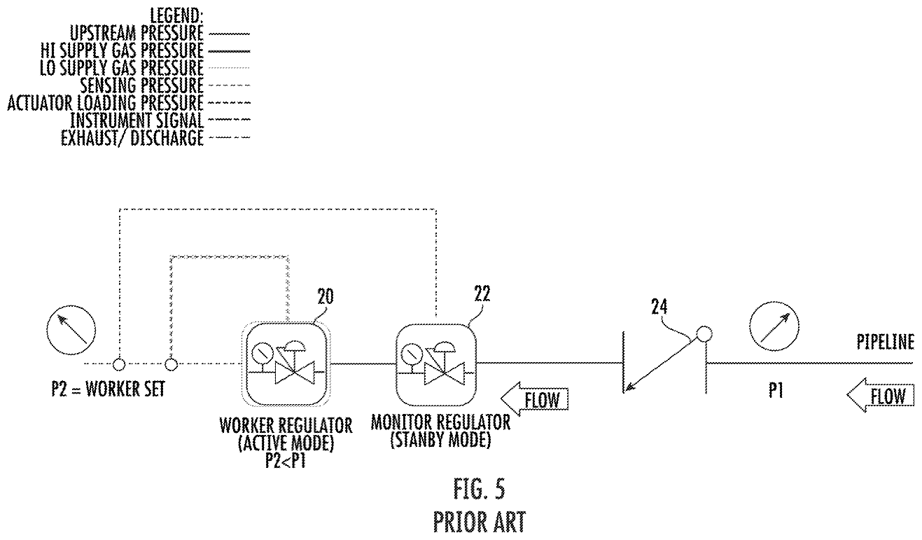

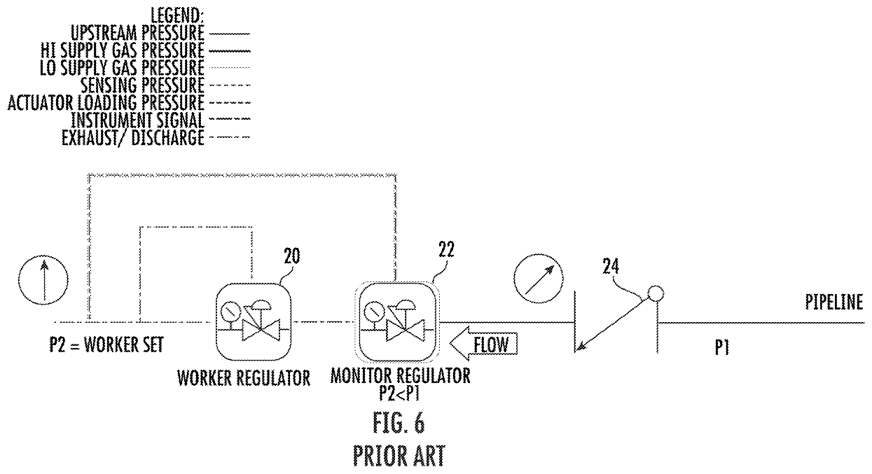

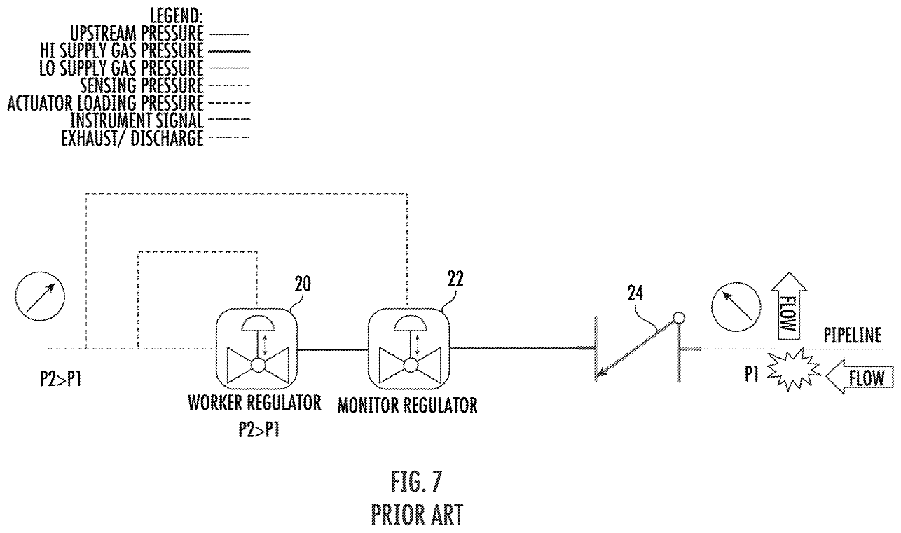

A schematic of the prior art use of a check valve 24 to prevent flow reversal in a gas line 100 is illustrated in FIGS. 1 and 5-7. The addition of the check valve 24 is a time-consuming and costly undertaking requiring annual maintenance. The issue of flow reversal is more readily addressed by the present invention, which adds upstream pressure sensing and valve control to an existing control valve system.

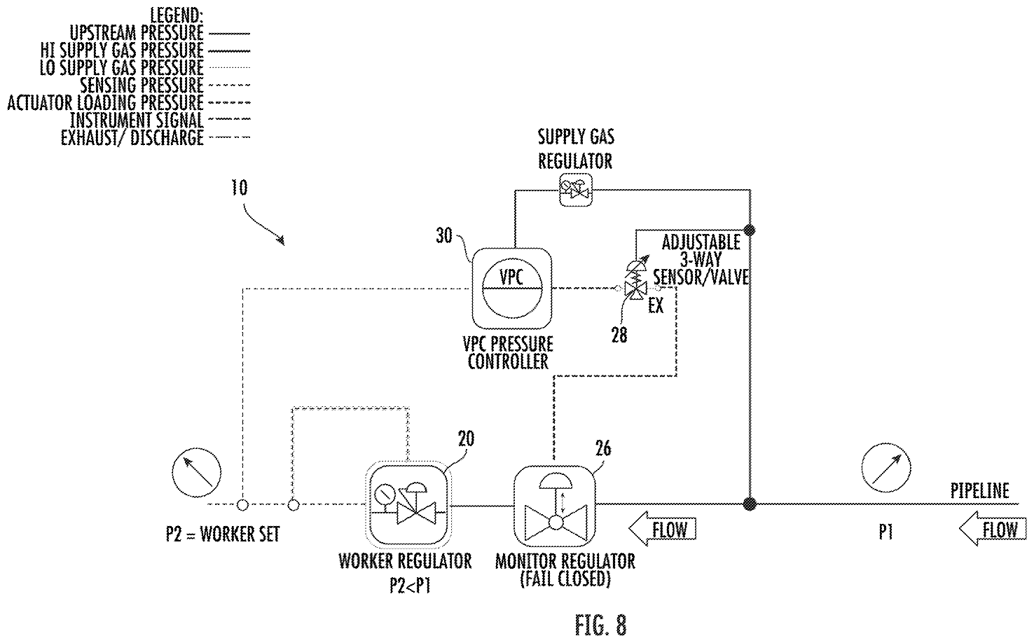

Referring to FIGS. 8-10, there is illustrated a control system 10 for a natural gas supply line 100. The particular illustrated supply line 100 has a preferred upstream pressure (P1) in the range of 230 to 500 psig, while the downstream preferred pressure (P2) is 160 psig. Obviously, other set points for P1 and P2 pressures would be similarly addressed by the disclosed system 10. The control system 10 maintains the set pressures by continuously monitoring both pressures. Generally speaking, the control system 10 comprises a worker regulator 20, a monitor control valve 26, and a pressure controller 30 with pressure sensing capabilities both upstream (P1) and downstream (P2). The monitor control valve 26 has an inlet side (upstream), an outlet side (downstream), and is controlled by a trigger valve 28 via the pressure controller 30.

The monitor control valve 26 used for the disclosed system 10 may be either a rotary control valve or a linear control valve as manufactured and sold by Assignee, VRG Controls, LLC. (see https://www.vrgcontrols.com/control-valves). Further, while all the embodiments illustrated are directed to a natural gas supply line, it should be understood that the principles of the invention can be more broadly applied to most any fluid delivery system where reverse flow presents an issue.

As can be seen in FIG. 8, the system 10 is in normal operation. The worker regulator 20 is used to reduce the preferred “normal” upstream pressure (P1) of 230-500 psig to a preferred “normal” downstream pressure (P2) of 160 psig. The monitor control valve 26 is in full open, allowing the worker valve 20 to control flow pressure.

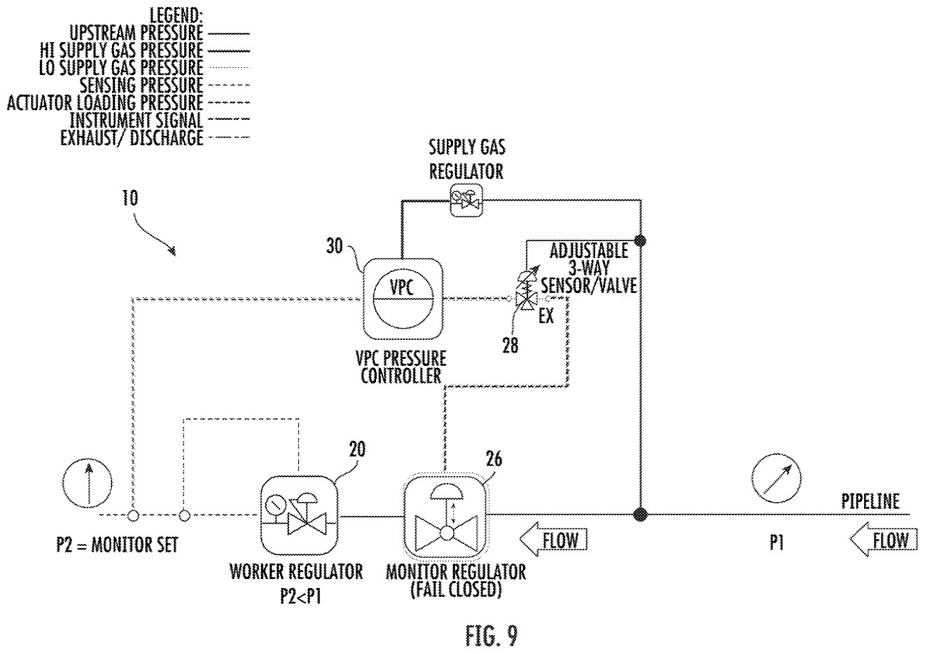

Referring now to FIG. 9, the schematic illustrates control failure of the worker regulator 20. This failure allows excess pressure in the downstream flow to reach a level greater than the preferred “normal” 160 psig. This is considered a potential “over-pressure” condition. To prevent further climbing of the downstream (P2) pressure, the VPC pressure controller 30 senses the downstream pressure increase and transmits loading pressure to the monitor valve through a normally open adjustable sensor/valve 28. Sensor/valve 28 shall pass through the output pressure from the monitor controller 30 when upstream pressure is in excess of adjustable 3-Way sensor valve setpoint 28.

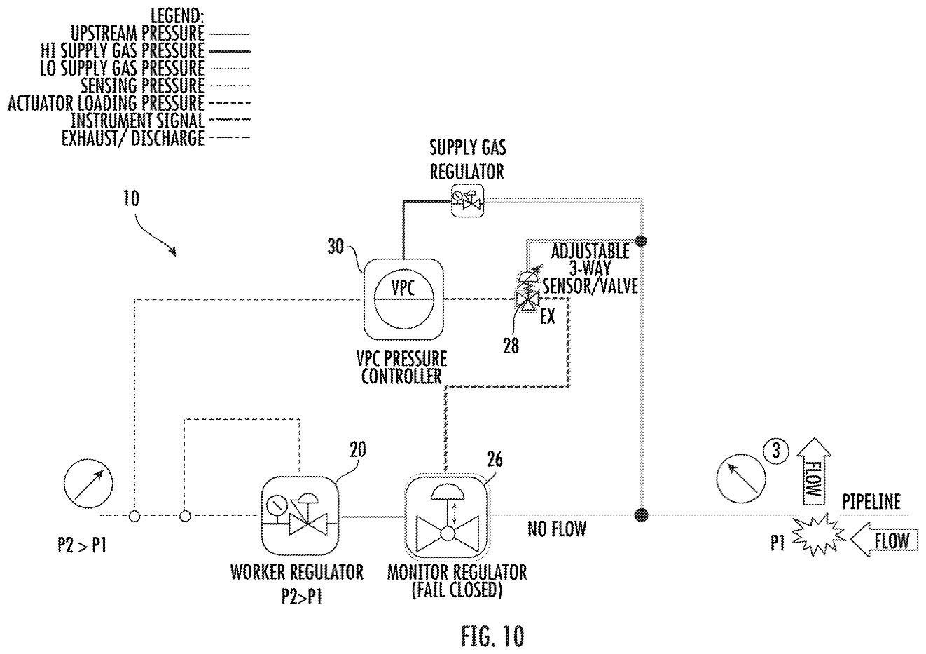

Referring to FIG. 10, the schematic illustrates a situation where an upstream event (e.g., a line rupture) has caused a drop in upstream pressure (P1). While the worker regulator 20 is operating normal to maintain downstream pressure (P2) at the preferred “normal” 160 psig, the low and dropping upstream pressure will eventually cause a flow reversal in the gas line—i.e., backflow. The upstream adjustable 3-way sensor/valve pressure , which is set to 220 psig—i.e., below the lowest preferred “normal” upstream pressure of 230 psig—is immediately triggered and signals the upstream adjustable 3-Way sensor valve 28 (a three-way, two-position valve) to react. The adjustable 3-Way sensor valve 28 sends the monitor control valve 26 into a full-closed position, thereby preventing reverse flow in the gas line 100.

The control valve 26 is able to close much earlier than the check valve of the prior art, thereby preventing a greater loss of product. The control valve 26 may be a pressure regulator but must have a guaranteed physical close to be used in the disclosed system 10.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A gas supply line control system comprising:
a monitor control valve having an inlet, an outlet, and a mechanism for moving within a range between and including a fully open position and a fully closed position to control gas flow in the gas supply line, wherein gas flows from upstream to the inlet, to downstream through the outlet;
a first sensor for determining a flow pressure upstream of the monitor control valve inlet;
a second sensor for determining a flow pressure downstream of the monitor control valve outlet;
an adjustable valve responsive to the first sensor and coupled to the monitor control valve;
wherein the adjustable valve:
closes the monitor control valve mechanism to prevent reverse gas flow when the first sensor determines an upstream pressure below a first predetermined value, and throttles the monitor control valve mechanism to regulate gas flow when the second sensor determines a downstream pressure above a second predetermined value.

2. The gas supply line control system of claim 1, wherein the first sensor comprises an adjustable 3-Way sensor valve.

3. The gas supply line control system of claim 1, wherein the adjustable valve comprises a 3-Way sensor valve.

4. The gas supply line control system of claim 1, further comprising a worker control valve downstream of the monitor control valve.

5. The gas supply line control system of claim 4, wherein the worker control valve is responsive to a third sensor downstream of the worker control valve and upstream of the second sensor.

6. The gas supply line control system of claim 1, wherein the first predetermined value for upstream pressure is greater than 220 psig.

7. The gas supply line control system of claim 1, wherein the monitor control valve is a rotary control valve.

8. The gas supply line control system of claim 1, wherein the monitor control valve is a linear control valve.

9. A gas supply line control system comprising:
a monitor control valve having an inlet, an outlet, and a mechanism for moving within a range between and including a fully open position and a fully closed position to control gas flow in the gas supply line, wherein gas flows from upstream to the inlet, to downstream through the outlet;
an adjustable 3-Way sensor valve for determining a flow pressure upstream of the monitor control valve inlet;
wherein the adjustable 3-Way sensor valve closes the monitor control valve mechanism to prevent reverse gas flow when the upstream flow pressure falls below a first predetermined value.

10. The gas supply line control system of claim 9, further comprising a second pressure sensor for determining a flow pressure downstream of the monitor control valve outlet.

11. The gas supply line control system of claim 10, wherein the monitor control valve throttles the gas flow when the second pressure sensor detects a downstream pressure exceeding a second predetermined value.

12. The gas supply line control system of claim 11, wherein the second predetermined value is 160 psig.

13. A method for preventing flow reversal in a natural gas supply line due to an upstream pressure drop, the method comprising:
setting a threshold low pressure for gas flow upstream of a monitor control valve;
continually sensing the gas flow pressure upstream of the monitor control valve;
closing the monitor control valve when the flow pressure upstream of the monitor control valve falls below the threshold low pressure to prevent reversal of flow in the gas supply line.

14. The method of claim 13, further comprising opening the closed monitor control valve when the upstream pressure exceeds the threshold low pressure.

15. The method of claim 13, wherein the monitor control valve is a rotary control valve.

16. The method of claim 13, wherein the monitor control valve is a linear control valve.

17. The method of claim 13, further comprising throttling gas flow with the monitor control valve when gas flow pressure downstream of a worker regulator exceeds a predetermined value.
